(19) United States
(12) Patent Application Publication
(10) Pub. No.: US 2014/0278849 A1
(43) Pub. Date: Sep. 18, 2014

(54) METHODS AND SYSTEMS FOR INTERNET-BASED MULTI-LEVEL MARKETING

(71) Applicant: Shophounds, LLC, Superior, CO (US)

(72) Inventor: Bruce Harrington, Superior, CO (US)

(73) Assignee: Shophounds, LLC, Superior, CO (US)

(21) Appl. No.: 14/210,222

(22) Filed: Mar. 13, 2014

Related U.S. Application Data
(60) Provisional application No. 61/785,172, filed on Mar. 14, 2013.

(51) Int. Cl. G06Q 30/02

(52) U.S. Cl. CPC G06Q 30/0274
USPC 705/14.7

(57) ABSTRACT

Methods and systems for operating a multi-level marketing program on the Internet are disclosed. In one aspect, a method includes associating a merchandiser with the first entity based on received first information, determining a first association chain for the first entity, determining a sales amount for the first entity based on the first association chain, determining a commission payment from the merchandiser to the first entity based on the sales amount, receiving, via the electronic device, second information associated with a second entity from the computer network, and using the second information to form a second association chain between the second entity and the first entity, associating purchases made by the second entity from the merchandiser with the first entity based on the second association chain, and generating, over the computer network, a commission payment to the first entity based on the associated purchases.

### CROSS-REFERENCE TO RELATED APPLICATIONS

This application claims the benefit of U.S. Provisional Application No. 61/785,172, filed Mar. 14, 2013, and entitled “METHODS AND SYSTEMS FOR CUSTOMERS AND THEIR FRIENDS TO BUY PRODUCTS ON THE INTERNET, AND RECEIVE A SALES COMMISSION ON THEIR PURCHASE,” the disclosure of which is hereby incorporated by reference in its entirety.

### FIELD

This disclosure relates generally to multi-level marketing (MLM), and more specifically, to Internet-based multi-level affiliate marketing.

### BACKGROUND

The Internet has become a tremendous venue for selling virtually every product and service available, and an unlimited number of companies are increasingly joining the Internet sales channel to enhance awareness of their products and gain market share. Many of these Internet merchants and/or vendors have developed what they refer to as “Affiliate Programs” to encourage other companies to promote the sales of the merchandisers' and/or vendors' products on or through their own websites. With the typical Affiliate Program a merchandiser and/or vendor pays an Affiliate Company a sales commission on the sale of all the merchandiser's and/or vendor's products and/or services that are sold on or through the Affiliate Company's website. Although this is a good marketing concept, and has been moderately effective in increasing the merchandiser's and/or vendor's sales, it has not generated substantial income for the Affiliate Companies because that market is highly competitive and the Affiliate Company typically doesn't provide much of an incentive, if any, for a consumer to purchase the products from the Affiliate Company website over another Affiliate Company's website or the merchandiser's and/or vendor's own website. In order to make an Affiliate Program successful for the Affiliate Company, the Affiliate Company must provide the proper incentive for the consumers to purchase the merchandisers' and/or vendors' products and/or services on the Affiliate Company's website over that of another Affiliate Company and the merchandiser and/or vendor.

### SUMMARY

Various implementations of methods within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims.

One aspect of the disclosure provides a method for establishing a new website company that can operate as a resource and management system to simplify and effectively make one or more Affiliate Programs available for any person or entity. Some aspects of the method include establishing a sophisticated MLM (multi-level marketing) management program on a website that is capable of establishing a person or entity as a “Primary Sub-Affiliate” of an Internet merchandiser, such as Amazon.com or Priceline.com, so that the Primary Sub-Affiliate can receive a sales commission that may be paid by the Internet merchandiser or another affiliated person or entity.

The MLM management program further provides a format for a Primary Sub-Affiliate to recruit his friends, or other persons or entities, to become Secondary Sub-Affiliates (also referred to herein as a “Tier N Sub-Affiliates”, where ‘N’ represents the position of the Secondary Sub-Affiliates with respect to the Primary Sub-Affiliate and may be any number) within the Primary Sub-Affiliate's group, and for the Primary Sub-Affiliate to be paid a percentage of a commission that may be paid to any or all Secondary Sub-Affiliates.

With this format Tier 1 Sub-Affiliates may then recruit their friends, or other persons or entities, who may become “Tier 2 Sub-Affiliates” of the Primary Sub-Affiliate, and so on, without limitation to the number of Tiers of Secondary Sub-Affiliates. All of the Primary Sub-Affiliates may make a percentage of the sales commission on all the Secondary Sub-Affiliates below them (also referred to herein as an “Association Chain”), which may generate an increasing amount of sales commissions over time as more Secondary Sub-Affiliates join and begin purchasing products. This method can also be used for Primary Sub-Affiliates to purchase products at or through a merchandiser's physical stores or other locations, rather than online, by integrating the Primary Sub-Affiliate's credit or debit card number, or other identifying information into the MLM program.

This method is unique because it creates a tremendous business advantage that is not known or otherwise employed within the merchandising industry. Some aspects of the methods disclosed herein incorporate a sophisticated Internet management program to create an Internet merchandiser's Affiliate Program—which, otherwise, is often only accessible to another Internet company—and make it easily accessible and effective for any person or entity to utilize. Some aspects of the methods further incorporate a MLM management program to integrate and track all product sales and other information of all Sub-Affiliates, and integrate them into a multi-tiered sales commission payment plan for the Sub-Affiliates.

The methods described herein provide a unique, simple, and very effective single source website that greatly reduces the time and hassle involved for a typical consumer to purchase products and services on the Internet. Additionally, the disclosed methods provide a unique, simple, motivating and effective way for a typical consumer to make an increasing amount of money for simply purchasing products and/or services from a more convenient source, and getting their friends or other persons or entities to do the same. Some aspects of the method incorporate two resources that have not been previously used together, to provide the following:

1. A person or entity can become a Primary Sub-Affiliate of a major brand merchandiser, and have the ability to obtain a sales commission from the merchandiser or another affiliated person or entity on all the products and/or services that they purchase.

2. A sophisticated online multi-level marketing management program that allows Sub-Affiliates to recruit their friends or other persons or entities to become Secondary Sub-Affiliates within their association chain and receive a sales commission on at least some things that a Sub-Affiliate's down-line Sub-Affiliates purchase.

Another aspect of the disclosure provides a method for taking advantage of Affiliate Programs using a very large number of vendors across a large spectrum of the marketplace, enabling the Affiliate Company to offer substantially all of the essential products and services, as well as most non-essentials, to consumers on one website. The method further includes a vendor or an Affiliate Company paying a portion of a commission from a vendor or another affiliated company to the consumers, its customers, in order to encourage the customers to purchase the vendor's products on the Affiliate Company's website. The Affiliate Company may pay a commission to its customers through a typical multi-level marketing program that further encourages its customers to tell their friends or others about the Affiliate Company's website, and invite them to become customers. The multi-level payment program enables the customers to make an increasing commission over time as they get more of their friends or others, and as their friends or others get more of their friends or others, to become customers.

This method is unique because it incorporates and adds to a number of existing methods to develop a new method that creates a tremendous business advantage that is not currently known or used within the industry.

The disclosed methods provide a unique, simple, motivating and effective single source website that greatly reduces the time and hassle involved for a typical consumer to purchase products and/or services on the Internet. Moreover, the disclosed methods provide a unique, simple, motivating and effective way for a typical consumer to make an increasing amount of money for simply purchasing their products and services from a more convenient source and by encouraging their friends and others to do the same.

### BRIEF DESCRIPTION OF THE DRAWINGS

FIG. 1 shows a simplified block diagram of an example hierarchy for primary sub-affiliates of a merchandiser/vendor and the primary sub-affiliates' associated secondary sub-affiliates.

FIG. 2 is a data flow diagram of one aspect of an affiliate program.

FIG. 3 is a flowchart of a process in accordance with one aspect of the subject matter disclosed.

FIG. 4 is a flowchart of a process in accordance with one aspect of the subject matter disclosed.

### DETAILED DESCRIPTION

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, structures and devices are shown in block form in order to avoid obscuring the novelty of the exemplary embodiments presented herein.

Disclosed are systems and methods for operating a multi-level marketing program over the Internet, where persons or entities can become sub-affiliates of an Internet merchandiser, thereby receiving commissions from the people in their association chain. The marketing program operated by the computer may be in some implementations characterized as a “hybrid” including certain aspects of multi-level marketing and affiliate marketing programs.

FIG. 1 shows a simplified block diagram of an example hierarchy 100 for primary sub-affiliates of a merchandiser and the primary sub-affiliates' associated secondary sub-affiliates. In an exemplary embodiment, one or more primary sub-affiliates 102a, 102b, 102c are associated with a merchandiser/vendor 101. A merchandiser/vendor 101 may be any person or entity that sells goods and/or services, which may be an Internet merchandiser. An Internet merchandiser may conduct at least some of their business online (i.e., sells at least some goods and/or services over the Internet) but may have physical stores, offices, warehouses, or other associated physical locations for conducting some of their business offline. In one exemplary embodiment, a merchandiser/vendor 101 is an Internet merchandiser such as Amazon.com or Priceline.com.

By way of example, FIG. 1 illustrates three primary sub-affiliates 102a-c. The association between a merchandiser/vendor 101 and a primary sub-affiliate 102a-c may include an exchange of information between the primary sub-affiliate 102a-c and a merchandiser/vendor 101, and such information may include a primary sub-affiliate's 102a, 102b, 102c identification information and/or financial information that will allow money to be transferred from a merchandiser/vendor 101 to a primary sub-affiliate 102a, 102b, 102c when purchases are made by someone in a primary sub-affiliate's 102a, 102b, 102c association chain 112a, 112b, 112c (e.g., commissions). Here, an association chain 112a, 112b, 112c refers to all entities that are a secondary sub-affiliate 120 of a primary sub-affiliate 102a, 102b, 102c, as illustrated in FIG. 1.

Secondary sub-affiliates 120 may also exchange information with a merchandiser/vendor 101. The information may include identification information and/or financial information that will allow money to be transferred from the merchandiser/vendor 101 to the secondary sub-affiliate 120 when purchases are made by an entity in the secondary sub-affiliate's 120 association chain. By way of example, the association chain of a tier 1 secondary sub-affiliate 104a, 104b, 104c, could include tier 2 sub-affiliates 106a, 106b, 106c, tier 3 sub-affiliates 108a, 108b, 108c, and tiers of sub-affiliates up the tier N sub-affiliates 110a, 110b, 110c, where N may be any number, here, any number greater than 3.

As shown in FIG. 1, each primary sub-affiliate 102a, 102b, and 102c may have an association with one or more “tiers” of secondary sub-affiliates 120, and each tier of secondary sub-affiliates 120 also may have an association with one or more tiers of secondary sub-affiliates. By way of example FIG. 1 illustrates each primary sub-affiliate 102a, 102b, 102c having tier 1 through N secondary sub-affiliates 120, where N may be any number. The tiers of secondary sub-affiliates 120 form the association chains 112a, 112b, 112c for each primary sub-affiliate 102a, 102b, 102c respectively. As illustrated in FIG. 1, each tier 1 sub-affiliate 104a, 104b, 104c may have an association with one or more tier 2 sub-affiliates 106a, 106b, 106c respectively. Each tier 2 sub-affiliate 106a, 106b, 106c may have an association with one or more tier 3 sub-affiliates 108a, 108b, 108c respectively. Each tier 3 sub-affiliate 108a, 108b, 108c may have an association with one or more tiers of sub-affiliates up to the tier N sub-affiliates 110a, 110b, 110c, where N may be any number, here, any number greater than 3.

In some implementations, there may be more or less tiers of sub-affiliates. For example, some implementations may have no tiers of sub-affiliates. Additionally, there is no requirement that a primary sub-affiliate association chain 112a-c has the same number of tiers as any other association chain 112a-c.

FIG. 2 is a data flow diagram of one aspect of an affiliate program 200. In one exemplary embodiment, a computer system 230 manages data among an affiliate company 240, a merchandiser 201, a vendor 203 a primary sub-affiliate 202, and secondary sub-affiliates 220a-c. In one exemplary embodiment, the computer system 230 may receive and manage data from a merchandiser 201, as well as send data back to the merchandiser 201. This data may include information about the merchandiser 201, information related to the sale of merchandiser's 201 goods and/or services, and information about all of the associations among the merchandiser 201, vendor 203, primary sub-affiliate 202 and secondary sub-affiliates 220a-c. In one exemplary embodiment, the association data may exist according to the tier system illustrated in FIG. 1. Further, this association data may be used to calculate commissions that are received based on purchases made by a primary sub-affiliate 202 and/or secondary sub-affiliates 220a-c.

A commission structure can be set-up in various ways. For example, a primary sub-affiliate 202 in FIG. 2 may be a primary sub-affiliate 102a, 102b, or 102c in FIG. 1. In these aspects, the primary sub-affiliate may have an association chain such as one of association chains 112a-c in FIG. 1. In some implementations, a primary sub-affiliate gets a commission from a purchase by anyone in their association chain for a certain number of tiers (for example, seven tiers). In other implementations, commissions are distributed to one or more people in a higher level tier (that is, a lower numbered tier) relative to the purchaser or customer of the goods and/or services. The idea being, that each person will work to get their friends or others signed-up under them to make their association chain as broad and/or long as possible, which also provides more commissions to those people “above” them in the chain.

In some aspects, the computer system 230 may be managed by an affiliate company 240. The computer system 230 may also send information to the affiliate company 240 associated with the management of the computer system 230 or the affiliate program 200. When primary sub-affiliate 202 or secondary sub-affiliates 220a, 220b, and 220c wishes to add another secondary sub-affiliate to their association chain, they may provide information to the computer system 230 necessary to facilitate the identification of the new secondary sub-affiliate and the computer system 230 may manage this information. For example, this information may include one or more other entities they are associated with, and financial information for payment of commissions. The computer system 230 may track purchases made, and automatically distribute commissions to the primary sub-affiliate 202 and/or each secondary sub-affiliate 220a, 220b, and 220c based on a determined pay-out scheme.

The computer system 230 may also allow for real-time accounting. For example, participants may be provided with an ability to track their commissions and to obtain a quick commission pay-out. This allows a person or entity to see their own wealth accumulate as a direct result of their work in building an association chain.

The computer system 230 may also send and receive data from vendor 203. This data may include information about the vendor 203 as well as information about the vendor's 203 goods and/or services. In one exemplary embodiment, a vendor 203 may pay a primary sub-affiliate 202 and/or secondary sub-affiliates 220a, 220b, and 220c for the purchases they make of the vendor's 203 goods and/or services. In another exemplary embodiment, primary sub-affiliate 202 and secondary sub-affiliates 220a, 220b, and 220c are associated according to the exemplary hierarchy 100 of FIG. 1.

FIG. 3 is a flowchart of a method 300 in accordance with one aspect of the subject matter disclosed. In this method, information and events are controlled by MLM software 350, a main site 360, affiliate networks 370, and a program for handling commissions 380 to form one exemplary embodiment of an affiliate program. MLM software 350 handles some of the information associated with existing users 302 and new users 304, 306. In one exemplary embodiment, the MLM software may be the Your Solutions Platform.

An existing user's flow begins at start block 302. In block 312, the user may login to a member back office from a replicated site of a corporate site. In block 322 the details associated with the user may then be passed to a main site. In block 390, the information associated with the user, such as user identification, first name, last name, email, etc. may be passed to an affiliate network. In block 330, the user may follow hyperlinks to the affiliate network sites. According to one exemplary embodiment, the user details must be persistent. According to another exemplary embodiment, a program may pass user details to a main site 360, the main site 360 may pass details to affiliate networks 370, and affiliate networks 370 may send files or other information back to a main site 360 with the same user details. In one exemplary embodiment, the main site may be a site such as BuyPlus.com.

In block 332, the user arrives at an affiliate network site. The user may browse or purchase products and/or services on or through the affiliate networks 370. According to one exemplary embodiment, all billing, shipping, and taxation for purchases on the affiliate network sites 370 are handled by the individual affiliates. In block 336, files may be sent to/from the affiliate networks 370 to the main site 360. In block 338 a program handling commissions 380 can periodically process batches of information, including user details, description, commission value, etc. In another exemplary embodiment, the program handling commissions 380 can process information on a substantially persistent basis rather than in batches. In block 340 the program handling commissions 380 can also create e-Wallet entries for commission payouts. In block 342, members can request commission withdrawals, and in block 344 the program handling commissions 380 can generate commission payout files. In one exemplary embodiment, the program handling commissions may be the Your Solutions Platform.

Start block 304 is a flow entry point for a new user. In some cases, the new user may visit a replicated site or corporate site in block 314. In block 324, the details associated with the user may then be passed to a main site. Process 300 then continues from block 324 as described above.

Another new user flow begins at start block 306. In block 316, the new user visits a main site. In block 326, the main site detects that there is an unknown user, and information about the new user may then be routed to a user platform. From block 314, process 300 may continue as described above.

FIG. 4 is a flowchart of a process 400 in accordance with one aspect of the subject matter disclosed. This flowchart demonstrates one possible method for handling users in one form of an affiliate program. A new user flow may start at block 402. The new user may visit a main site, and in block 404 the main site may advertise goods and/or services. In one exemplary embodiment, the main site may be Shophounds.com.

At decision block 406 a decision is made as to whether the new user was sold on the main site. If the user was not sold on the main site, then a condition new user lost 408a may be created. If the user was sold on the main site, then process 400 moves to block 410 which determines how the user was referred. Decision block 412 determines whether the referrer was obtained successfully. If the referrer was not successfully obtained, then process 400 moves to block 422 where the user may be required to sign a waiver stating there was no referral. The user may then be registered and randomly placed within a genealogy. If the referrer was successfully obtained in decision block 412, process 400 moves to block 418. In block 418, the user registers and is placed under the referrer in a genealogy.

From either block 418 or 422, process 400 moves to block 430. In block 430, the user may log in with their username and password. The user may also be tracked with an identifier. In one exemplary embodiment, the identifier may be a session identifier (SID). In block 440, the user may then click affiliate links to browse and/or shop. In block 442, the user's identifier may be passed to affiliate sites.

Decision block 444 determines whether the user made a purchase on or from an affiliate site. If no sale was made, process 400 moves to block 446, where a condition for no sale is recorded. If the user did purchase an item from the affiliate, process 400 moves from decision block 444 to block 448, where the affiliate site handles the transaction. This may include payment, processing, and shipment.

Next, process 400 moves to decision block 450, which determines whether the affiliate site participates in real time posts for transactions. If the affiliate does not participate, process 400 moves to block 452 where the affiliate site may send period batch files to commission software. These files may include transaction information, such as user identifiers, purchase amounts, and commission amounts. If the affiliate does participate, process 400 moves from decision block 450 to block 454, where the affiliate site may send real time transaction information to commission software. This information may include user identifiers, purchase amounts, and commission amounts.

From either block 452 or 454, process 400 moves to block 456, where the commission software may then post transaction details back to the MLM software. In one exemplary embodiment, the software commission software may be CJ Affiliate software by Conversant®. In block 458, the MLM software may process and import transaction details, further distributing commissions as per a MLM model into members' accounts. In block 460 if a member's balance is over a threshold, for example $20, the member can initiate a withdrawal. In some aspects, the withdrawal may occur via paper check, a transfer into a bank account, by loading a credit card or debit card, or by some other method.

Alternatively, a new user starting at block 402 may instead surf to a replicated site in block 414 where the main site may advertises goods and/or services, and referrer identifier may be tracked. In decision block 416, it may be determined whether the new user was sold on the main site. If the user was not sold on the main site, then a condition for a new user lost 408b may be created and/or handled. If the user was sold on the main site, in block 418 the site may register the user and place the user under a referrer in the genealogy. From block 418, process 400 may continue as described above.

An existing user may start method 400 at block 420. At block 430, the user may log in to the main site with their username and password, and the user may be tracked with an identifier. Process 400 may then continue from block 430 as described above.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and Blu-ray® disc where disks usually reproduce data magnetically, while discs reproduce data optically with lasers. Thus, in some aspects, computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method of operating a multi-level marketing program on the Internet, comprising:
receiving, via an electronic device, first information associated with a first entity from a computer network;
associating a merchandiser with the first entity based on the received first information; determining, via an electronic processor, a first association chain for the first entity;
receiving, via the electronic device, second information associated with a second entity from the computer network, and using the second information to associate the second entity with the first association chain;
associating purchases made by the second entity from the merchandiser with the first entity based on the first association chain;
determining a sales amount for the first entity based on purchases associated with the first association chain;
determining a commission payment from the merchandiser to the first entity based on the sales amount; and
generating, over the computer network, the commission payment to the first entity.

2. The method of claim 1, further comprising:
receiving via the electronic device, third information associated with a third entity from a computer network, and using the third information to associate the third entity with the first association chain; and
associating purchases made by the third entity from the merchandiser with the first entity based on the first association chain.

3. The method of claim 2, further comprising receiving the first information, second information, or third information from a plurality of computing devices, each associated with at least one entity providing the information.

4. The method of claim 3, wherein the plurality of computing devices comprise wireless communication devices, tablet computers, laptop computers and desktop computers.

5. The method of claim 1, further comprising determining the commissions paid to the first entity based on a pre-determined commission scheme.

6. The method of claim 2, further comprising:
determining via an electronic processor, a second association chain for the second entity;
associating the third entity with the second association chain;
associating purchases made by the third entity from the merchandiser with the second entity based upon the second association chain; and
determining commissions to be paid from the merchandiser to the second entity based on purchases associated with the second association chain.

7. The method of claim 2, wherein the marketing program is controlled by a computer system.

8. The method of claim 7, wherein the computer system is controlled by an affiliate company.

9. The method of claim 8, wherein the computer system is configured to determine commissions for a plurality of merchandisers and vendors.

10. The method of claim 1, wherein the method is performed iteratively.

11. An apparatus for operating a multi-level marketing program on the Internet, comprising:
a processor;
a memory, operatively coupled to the processor, and configured to store instructions that when executed cause the processor to perform a method comprising:
receive first information associated with a first entity from a computer network;
associate a merchandiser with the first entity based on the received first information;
determine a first association chain for the first entity;
receive second information associated with a second entity from the computer network, and use the second information to associate the second entity with the first association chain;
associate purchases made by the second entity from the merchandiser with the first entity based on the first association chain;
determine a sales amount for the first entity based on purchases associated with the first association chain;
determine a commission payment from the merchandiser to the first entity based on the sales amount; and
generate, over the computer network, the commission payment to the first entity.

12. The apparatus of claim 11, wherein the memory stores further instructions that configure the processor to:
receive, via the electronic device, third information associated with an third entity from a computer network, and use the third information to associate the third entity with the first association chain; and
associate purchases made by the third entity from the merchandiser with the first entity based on the first association chain.

13. The apparatus of claim 12, wherein the memory stores further instructions that configure the processor to receive the third information from a plurality of computing devices, each associated with at least one entity providing the information.

14. The apparatus of claim 12, wherein the plurality of computing devices comprise wireless communication devices, tablet computers, laptop computers and desktop computers.

15. The apparatus of claim 11, wherein the memory stores further instructions that configure the processor to determine the commissions paid to the first entity based on a pre-determined commission scheme.

16. The apparatus of claim 12, wherein the memory stores further instructions that configure the processor to:
determine a second association chain for the second entity;
associate the third entity with the second association chain;
associate purchases made by the third entity from the merchandiser with the second entity based upon the second association chain; and
determine commissions to be paid from the merchandiser to the second entity based on purchases associated with the second association chain.

17. The apparatus of claim 11, wherein the marketing program is controlled by a computer system.

18. The apparatus of claim 17, wherein the computer system is controlled by an affiliate company.

19. The apparatus of claim 18, wherein the computer system is configured to determine commissions for a plurality of merchandisers and vendors.

20. The apparatus of claim 11, wherein the memory stores further instructions that configure the processor to perform the method iteratively.
